(19) United States
(12) Patent Application Publication
(10) Pub. No.: US 2017/0017976 A1
(43) Pub. Date: Jan. 19, 2017

(54) ELECTION INFORMATION AND DEMOGRAPHIC COLLECTION SYSTEM AND METHOD

(71) Applicant: MY INFORMED DECISION, LLC, River Falls, WI (US)

(72) Inventor: Andrew L. Gillis, River Falls, WI (US)

(21) Appl. No.: 15/212,243

(22) Filed: Jul. 17, 2016

Related U.S. Application Data
(60) Provisional application No. 62/193,862, filed on Jul. 17, 2015.

(51) Int. Cl. G06Q 30/02; G06F 17/30

(52) U.S. Cl. CPC G06Q 30/0204; G06F 17/30241

(57) ABSTRACT

A method for providing information on candidates and civic issues to the public while addressing the collection of demographic information on the general public and potential voters for dissemination to political

### CROSS-REFERENCE TO RELATED APPLICATION

This application claims priority to U.S. Provisional Patent Application No. 62/193,862 filed Jul. 17, 2016, the disclosure of which is herein incorporated by reference in its entirety.

### TECHNICAL FIELD

This application is directed at a system and method for providing information on candidates and civic issues to the public while addressing the collection of demographic information on the general public and potential voters for dissemination to political candidates, election officials and political scientists.

### BACKGROUND

Potential voters and the general public often seek information and data on issues and candidates during election periods. While certain information may be available on the interne and through other media outlets, it is not always in a format that is readily accessible and easily discernable. Additionally, potential voters and citizens wanting to remain informed often seek information from multiple sources on political and campaign issues. Detailed information and coverage on local and regional election matters can be particularly problematic for voters. Often times, information on local political races and issues can be stale or insufficient in overall depth or coverage.

Politicians, election officials, the media and political scientists are often seeking certain demographic information on the voting public in order to address campaign concerns, campaign strategies, understand tends, and offset trends. Conventional polling by political scientists is one method often relied upon to understand the voting public. However, polls have often been criticized for source errors, conveying a false sense of precision, and relying on assumptions that may be inconsistent with the real world working public. Additionally, the change in the way the voting public communicates, particularly with the prevalence and use of smart phones and social media, has skewed political polling.

### SUMMARY

The current voter information pages on internet web sites and in traditional media do not adequately offer up to date information and do not always address frequent demographic changes by the voting public in response to changing information on candidates or political issues. This disclosure is directed at a method that encompasses the dissemination of information to the general public and registered voters, and in response develops demographic information based on voter input that may be useful and insightful to candidates, political scientists, politicians, media personnel, and election officials.

The method comprises providing a database, accessible through the internet, with political candidate information, referendum information, election issues or various combinations of such information. Members to the system remotely access the database through any viable internet connecting device, such as a smart phone or computer. The database is readily accessed through a maneuverable interface. Members are solicited to join the site and to develop an individual demographic profile through the interface. Once an individual demographic profile is developed, members can review the database and develop informational pages specific to each individual member. The informational pages of an individual member contain a member's selected political candidate information, referendum information, election issues or combinations thereof.

The method of this disclosure creates insightful demographic information based upon the selective combination of a member's individual demographic information and member's interaction with the database's political candidate information, referendum information, and election issues. Demographics specific to political candidates, a referendum information, and an election issue are established through a combination of a member's, or multiple members', informational page with their respective individual demographic profiles.

The demographics may be useful to various customers that are able to access the demographic data directly from the database. The demographics are generally insightful to candidates, political scientists, politicians, media personnel, and election officials. Additionally, in certain embodiments, the demographics may be revised in essentially real time to reflect changes largely due to the social media and broad use of hand held devices that grant access to such members.

Demographics may include gender, age, ethnicity, knowledge of languages, disabilities, mobility, home ownership, household income, marital status, employment status, geographic location, decision changes on candidates, decision changes on issues, information queries, time reviewing candidates or issues before making an informed decision, and combinations thereof.

The following terms used in this disclosure are defined as follows:

“Access Key” refers to a code generated by our system that allows an entity to sign into our web site.

“AJAX” means a client-side script that exchanges data with a server and updates parts of the webpage.

“API Key” means a code used to control how the API is used.

“Application Program Interface (API)” refers to routines and protocols that specify how software components should interact with each other.

“Candidate Tree” means a member's listing of candidates or referendum issues and relevant data for such matters relevant to a member's location and/or school district.

“Component-based Library” means an object-oriented approach used to send emails from PHP applications.

“Customer” any entity or individual that enter political candidate information, referendum information, election issues or purchases demographic information of potential voters, voting tendencies of demographics, or voting tendencies.

“Database” means a set of data held in our system that is accessible in many ways.

“Favors” means a tool offered to a member that assists in reducing the entire pool of political candidate information, referendum information, and election issues to a list the member wishes to pursue further for personal reasons, whether educational or other.

“JavaScript” means an object-oriented computer programming language.

“JavaScript Object Notation (JSON)” refers to a data interchange format that defines models.

“Member” A user that signs up for a membership by filling out a demographic questionnaire in exchange for benefits within the site such as the ability to populate a list of preferred candidates, saved preferences, etc.

“MySQL” refers to a relational database management system.

“Object-Relational Mapping (ORM)” refers to a technique that uses an object-oriented paradigm to query and manipulate data from a database to which ultimately converts data between incompatible type systems.

“PHP” means a script based computer programming language and interpreter.

“Remote Access” means the utilization of a computer or smart phone to access the database through the internet.

“Template Engine” means a system that combines templates in a data model to produce web documents.

“User” means any member of the public that wishes to use the site.

The disclosure may be understood more readily by reference to the following drawings and the detailed description of the various features described therein.

### BRIEF DESCRIPTION OF DRAWINGS

FIG. 1 is a flow diagram of one embodiment of a method of this disclosure.

FIG. 2 is an example of one embodiment of a candidate tree.

FIG. 3 is a flow diagram of a process to develop a candidate tree.

FIG. 4 is an embodiment of a favorites page.

FIG. 5 is a flow diagram of a process to develop a favorites page.

FIG. 6 is an example of an embodiment of a candidate comparison.

FIG. 7 is a flow diagram of a process to compare candidates.

FIG. 8 is a flow diagram of a process for maintaining current information on federal referendums.

### DETAILED DESCRIPTION

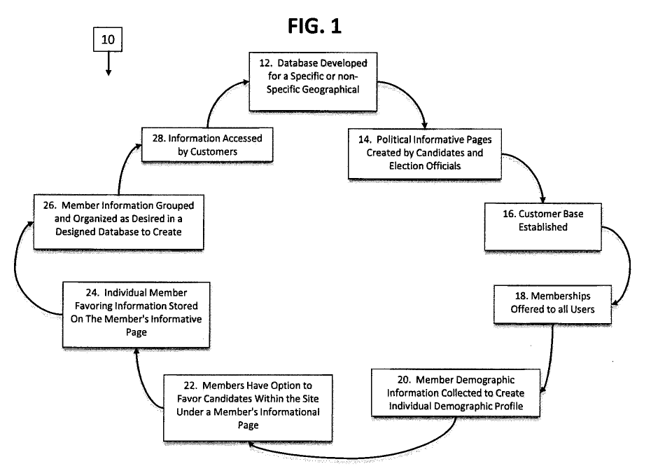

FIG. 1 depicts a method suitable under the present disclosure for providing information on candidates and civic issues to the public while addressing the collection of demographic information on the general public and potential voters for dissemination to political candidates, election officials and political scientists. One embodiment of the method is demonstrated by diagram 10 that depicts an initial phase 12 of developing the database for geographic areas. Political or referendum pages in phase 14 of the method may be created by candidates or election officials. This occurs multiple times to establish a customer base 16. Memberships are offered to various users that access the customer base 18. A member, upon joining, will enter specific individual information thereby creating an individual demographic profile 20. Members then utilize the information provided by the customer base 16 to make choices under a member's informational page 22. An individual member's favored candidate or issue information is then stored on the member's informational page 24 and used to create demographic information 26. The demographic information developed through the use of the members may be accessed for review by the customers 28.

In one embodiment, a database is provided with political candidate information, referendum information, election issues or combinations thereof, wherein the database is accessible by remote access. Members are solicited through remote access to develop an individual demographic profile. Members are then allowed to review the database and develop informational pages specific to each individual member. The informational pages of an individual member contain a member's selected political candidate information, referendum information, election issues or combinations thereof. A member's informational page is then aligned with a member's individual demographic profile to establish demographics specific to political candidates, a referendum information, an election issue or combinations thereof. At least of portion of the demographics may then be remotely accessed and optionally transferred by various customers.

The method as described through this disclosure is intended to permit the member to make an informed decision, by way of favoring, with respect to political candidates, referendums, and other election issues for a member's specific area of interest. An area of interest may include various political races or ballot issues for a geographical area. When a member makes an informed decision, the demographics on the database are updated or revised. The informed decision should not be considered as a vote. In certain embodiments, the member can make an informed decision on every candidate from a race, multiple candidates, one candidate, or no candidates at all. The member is not limited to making an informed decision on their particular polling area. The decision is not an official choice nor is it a selection necessarily meant to be the candidate(s) that will be chosen by the user during the official election.

The database is populated by customers or others with specific information on candidates, referendums, and election or ballot issues. The customers may be individuals or entities from which information is elicited. For example, customers may include political scientists, politicians, media personnel, election officials and combinations thereof. In certain circumstances, the customer may be individuals or entities that a have stake in the election, such as candidates and citizens or groups supporting a particular issue. In some embodiments, the information may include candidate profiles, candidate position, elected official records, positions on election issues, referendum background information, impact of referendum choices, candidate party alliance, endorsements, and combinations thereof.

Members and the general public are able to access the database. However, members are solicited to provide specific demographic information by creating an individual demographic profile. Non-limiting examples of an individual demographic profile include individual information related to gender, age, ethnicity, knowledge of languages, disabilities, mobility, home ownership, household income, marital status, employment status, political party affiliation or geographic location. This profile is subsequently aligned with a member's informational page or pages to establish demographics.

Members may establish informational pages to enhance the individual's understanding of the political issues, candidates, or referendums. Informational pages enable a member to selectively populate a display of candidates or issues that may be aligned with a specific geographical area in order to investigate and make an informed decision. Non-limiting example of items or data that may be placed on a member's informational page or pages includes candidate profiles, candidate positions, elected official records, positions on election issues, referendum background information, impact of referendum choices, candidate party alliance, endorsements, and combinations thereof.

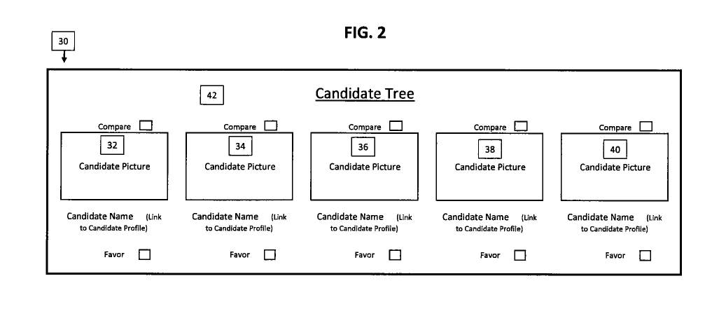

A further non-limiting example of a specific informational page is the candidate tree page depicted in FIG. 2. FIG. 2 is directed to a matrix 30 that lists candidates 32, 34, 36, 38, and 40 for a particular geographic location. This page may be utilized to review relevant information on a specific candidate or candidates in a particular geographic location. The format enhances the ability to compare candidates and eventually narrow the field for further comparison or review. The member can favor candidates from this page based on geographic location. The candidate tree should not be considered the same as what will show on a member's ballot as the displayed candidates on the candidate tree are not limited to a current election season. The candidate tree is able to store candidates from past elections and is able to store candidates from future elections. This format increases the ability for the member to more deeply determine the experience or qualification level of a candidate when using the comparison option against all candidates, past, present, or future, specific to the member's geographic location. This method of organization creates value to those customers who have run for past, current, and future elections by providing an avenue for candidates to keep current their information on experience, events, beliefs, and all other relevant current information specific to their location. Use of information organized in this manner inherently makes the use of this method valuable for those customers regardless of past, present, or future election if they wish to remain relevant in the political environment for the geographical area.

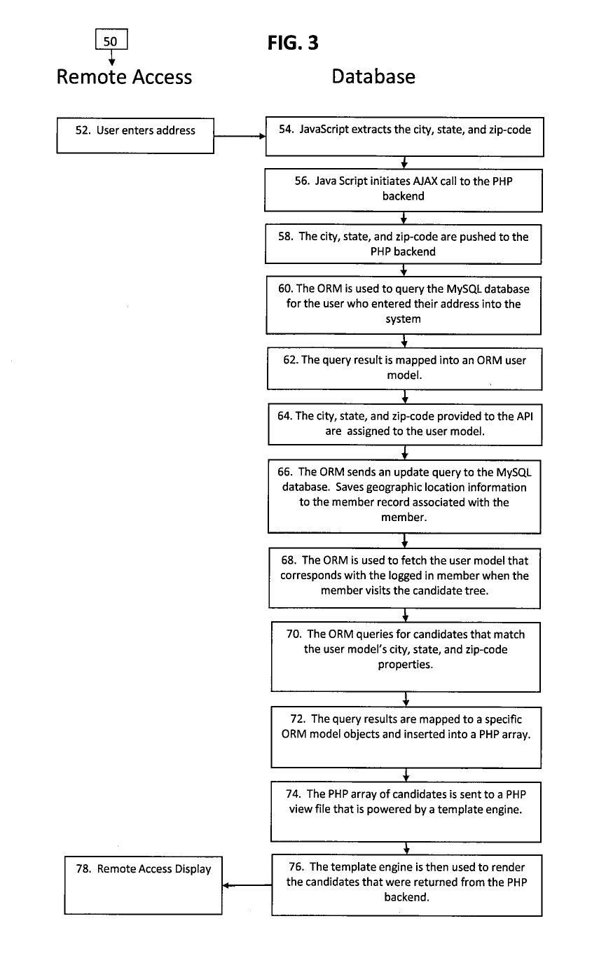

In certain embodiment, once a candidate is favored, the database can be populated and demographic data created based on that decision is stored for example, in the MySQL database. The process of organizing and storing data based on location for past, present, and future candidates may use a multitude of computer languages and programming techniques. FIG. 3 depicts one non-limiting example of a process 50. The process 50 incorporates remote access activities that either correspond or trigger database activities. A user may enter their address or relevant location information into the database 52. The system then employs JavaScript to extract the city, state, and zip-code provided by the user 54. JavaScript may initiate an AJAX call to the PHP backend 56. As a result, the city, state, and zip-code are pushed to the PHP backend 58 to store the information in the system. The stored information is then subject to recall for organization and additional system needs. Then the Object-Relational Mapping (ORM) is used to query the MySQL database for the member who entered their address into the system 60 to match the location data with a specific member. The query result may then be mapped into an ORM user model 62. The city, state, and zip-code provided to an Application Program Interface (API) are then assigned to the user model 64. The specific ORM is then used to send an update query to the MySQL database. This query saves the city, state, and zip-code to the member record associated with the logged in member 66. When the member visits the candidate tree, the specific ORM is used to fetch the user model that corresponds with the logged in member 68. The system then uses specific ORM to query for candidates that match the user model's city, state, and zip-code properties 70. The results of the query are mapped to specific ORM model objects and then inserted into a PHP array 72. The PHP array of candidates is then sent to a PHP view file that may be powered by a template engine 74. The template engine is then used to render the candidates that were returned from the PHP backend 76. One of ordinary skill in the art will recognize that the informational page of a member may contain more than one selection in a specific category of each of a political candidate, referendum, or election issue.

In another embodiment, candidate information relevant to a school district is pulled when a user enters their relevant school district during setup by the specific ORM. Information for school districts are stored in the MySQL database and when a user selects a district during the member signup process. The information for the customer relevant to that district is pulled using information stored in the MySQL database with a specific ORM. The candidates relevant to a member in our data base for that school district that have run for election, are running for election, or may run for election are pulled to the same page for the member as are the customers based on the district entered during sign-up. When the member visits the page, a specific ORM may be used to fetch the user model that corresponds with the logged in member.

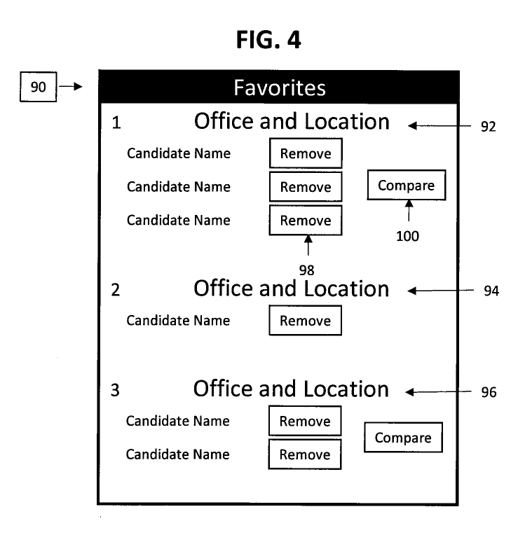

In one embodiment, a list of preferred candidates, in the form of a favorites page, may be created as an additional information page for a member by favoring a candidate. FIG. 4 is one non-limiting illustration of a favorites listing. A table 90 includes a list of the favored candidates for individual offices 92, 94, 96, or for referendum issues (not shown). The list of favored candidates 90 is a tool for the member to further narrow down their pool of preferred candidates. The member is given the option to remove candidates 98 from the list. When such an action is taken, the demographic information and the candidate name is matched in the internal database. The cell that was originally populated as added on the matching candidate and demographics line may be relabeled as removed, indicating the candidate was removed from a preferred candidate list.

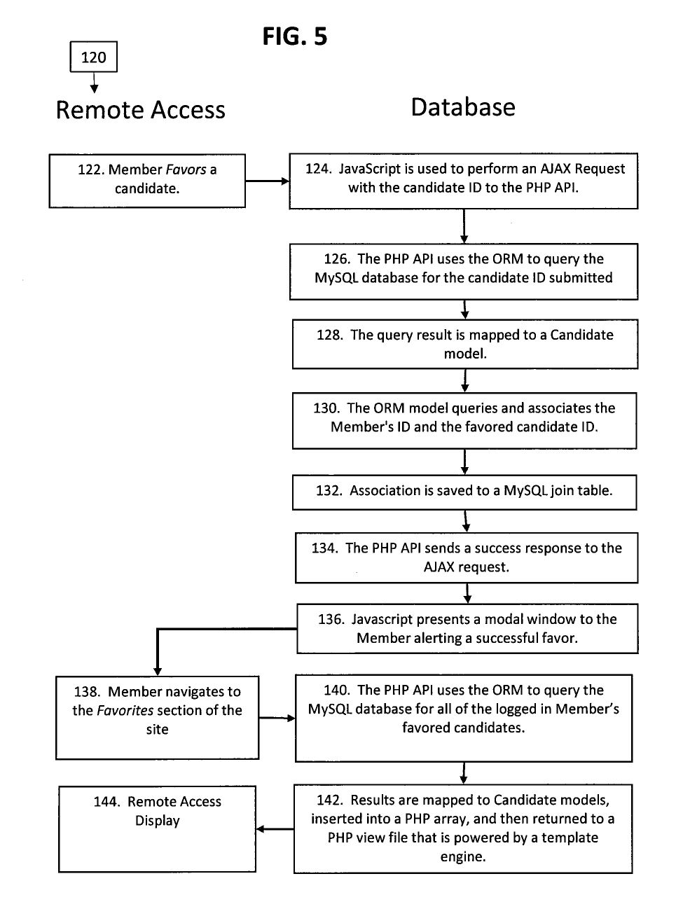

FIG. 5 illustrates at least one designed process 120 to select, pull, and organize a member's favored candidates to their Favorites Page. The process 120 incorporates remote access activities that either correspond or trigger database activities. When the member favors a candidate 122, JavaScript is initiated to perform an AJAX request with the candidate identification (ID) to the PHP API 124. The PHP API uses a specific ORM to query the MySQL database for the candidate that corresponds to the ID submitted by the AJAX request 126. The result of the query is then mapped to a candidate model 128. The specific ORM model is used to create a query that associates the member's ID and the ID of the favored candidate 130. The association is then saved to MySQL to allow for future queries of the member's favorites 132. The PHP API then sends a success response to the AJAX request and a modal window alerts the member of a successful add 134. When the member navigates to the Favorites Page 138, the PHP API uses the ORM to query the MySQL database for all of the logged in member's favored candidates 140. The results of this query are mapped to the candidate models, inserted into a PHP array, and then returned to a PHP view file that is powered by a template engine 142.

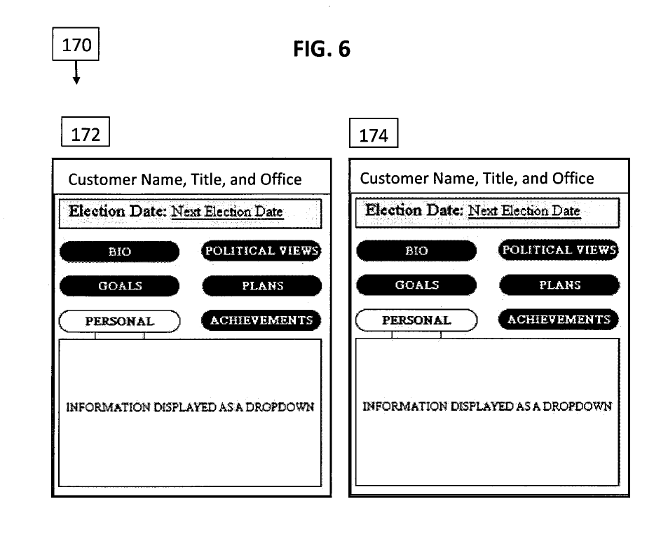

In an optional embodiment, a member can compare candidates on any of the entire list of database candidates, their candidate tree, and their favorites page. FIG. 6 is a non-limiting illustration of a comparative page 170. The comparison page includes selected information of selected candidates 172, 174 for review by the member. The member can review side-by-side comparisons with the candidates. The option to remove a candidate from the member's favorites list exists on the entire list of database candidates, their candidate tree, and their favorites page. When the action is taken to remove candidates from these pages based on the comparison, the demographic information and the candidate name is matched in the internal database via the specific ORM. The cell that was originally populated as added on the matching candidate and demographics line is relabeled as removed, indicating the candidate was removed from a preferred candidate list.

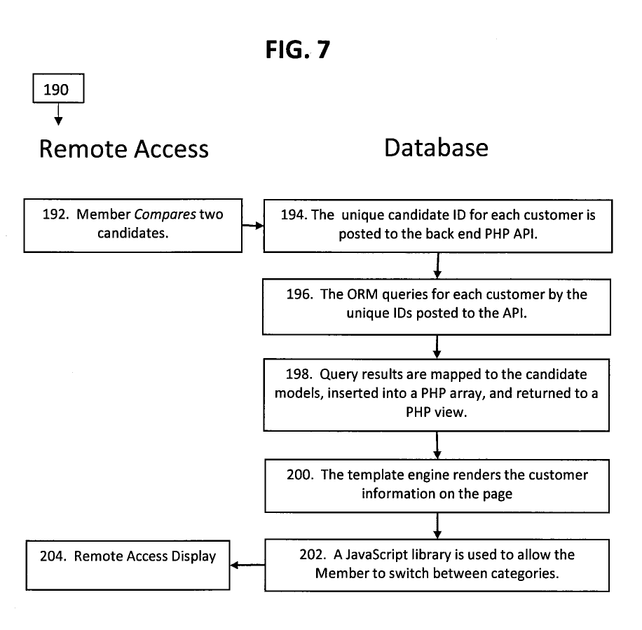

FIG. 7 is a non-limiting illustration of one process for rendering comparison data. FIG. 7 defines the back-end process flow designed to compare candidates 190. The process 190 incorporates remote access activities that either correspond or trigger database activities. When a member compares two candidates 192, the unique candidate ID for each customer may be posted to the back-end PHP API 194. The specific ORM queries for each customer by the unique ID's posted to the API 196, and the results are mapped to the candidate models, inserted into a PHP array, and returned to a PHP view file that is powered by a template engine 198. The template engine renders the customer information on the page 200. A JavaScript library can be used so the member is able to switch between the different categories of the comparison without the need to reload the page 202.

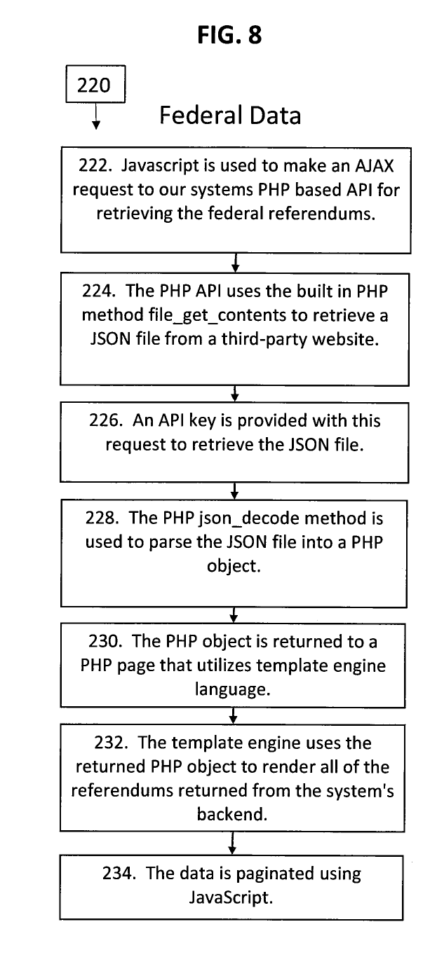

FIG. 8 depicts one embodiment of a design process for collecting data on federal referendums 220. In certain embodiments, JavaScript can be used to make an AJAX request to the PHP based API 222. The PHP API uses the built in PHP method to retrieve a JavaScript Object Notation (JSON) file from a third party database 224. An API key is provided with this request in order to retrieve the JSON file 226. Once the JSON file is fetched from the third party site, a PHP method may be used to parse the JSON file into a PHP object 228. This PHP object is then returned to a PHP page that utilizes the template engine language 230. The template engine uses the returned PHP object to render all of the referendums returned from the PHP backend 232. The rendered referendum data is then paginated using JavaScript to control the pagination 234. Pulling referendum data from this third party database presents up to date information to the member.

Local referendum information may be populated in the database by a member through remote access. The method of insertion of referendum data into the database is comparable to a customer inserting baseline information.

The database is designed to derive demographic data by aligning a member's informational page with a member's individual demographic profile to establish demographics specific to political candidates, a referendum, an election issue or combinations thereof. The method of this disclosure is capable of developing voter trends by compiling information from its members. In some embodiments, any action taken by a member can be utilized to develop or revise demographic data. This is may be done in real time to provide fresh and substantially instantaneous data to customers, particularly in light of updated news or information placed in the public domain though news and other social media applications.

A wide variety of demographic data may be derived from the member's interaction with the information pages and candidate or referendum listings. Non-limiting examples of demographics include gender, age, ethnicity, knowledge of languages, disabilities, mobility, home ownership, household income, marital status, employment status, geographic location, decision changes on candidates, decision changes on issues, information queries, time reviewing candidates or issues before making an informed decision, and combinations thereof.

The demographics are generally provided to customers through their access to the database. The customers may be individuals or entities from which information is elicited. For example, customers may include political scientists, politicians, media personnel, election officials and combinations thereof. The customers often seek trends and data in real time in order to make strategic decisions on campaign approaches and methodology. For example, the impact of stated positions by a candidate on a particular issue, advertisements, or the use of social media may be readily determined through changing demographics enabled by the method of this disclosure.

From the above disclosure of the general principles and the preceding detailed description, those skilled in this art will readily comprehend the various modifications to which the present method is susceptible. Therefore, the scope of the invention should be limited only by the following claims and equivalents thereof.

What is claimed is:

1. A method comprising,
(a) providing a database with political candidate information, referendum information, election issues or combinations thereof, wherein the database is accessible by remote access,
(b) soliciting members through remote access to develop an individual demographic profile,
(c) allowing members to review the database and develop informational pages specific to each individual member, wherein the informational pages of an individual member contain a member's selected political candidate information, referendum information, election issues or combinations thereof, and
(d) aligning a member's informational page with a member's individual demographic profile to establish demographics specific to political candidates, a referendum information, an election issue or combinations thereof.

2. A method according to claim 1, further comprising transferring at least a portion of the demographics to at least one customer.

3. A method according to claim 1, further comprising engaging customers to elicit political candidate information, referendum information, election issues and combinations thereof to develop the database.

4. A method according to claim 1, wherein the established demographics include gender, age, ethnicity, knowledge of languages, disabilities, mobility, home ownership, household income, marital status, employment status, geographic location, decision changes on candidates, decision changes on issues, information queries, time reviewing candidates or issues before making an informed decision, and combinations thereof.

5. A method according to claim 1, wherein the informational pages include candidate profiles, candidate positions, elected official records, positions on election issues, referendum background information, impact of referendum choices, candidate party alliance, endorsements, and combinations thereof.

6. A method according to claim 1, wherein the database is aligned with a specific geographical area.

7. A method according to claim 2, wherein the at least one customer includes political scientists, politicians, media personnel, election officials and combinations thereof.

8. A method comprising;
(a) utilizing customer input by remote access to develop a database with political candidate information, referendum information, election issues or combinations thereof, wherein the database is accessible by remote access and aligned with a geographical area,
(b) soliciting members through remote access to develop an individual demographic profile on the database,
(c) allowing members to review the database and develop informational pages specific to each individual member, wherein the informational pages include candidate profiles, candidate positions, elected official records, positions on election issues, referendum background information, impact of referendum choices, candidate party alliance, endorsements, and combinations thereof,
(d) aligning a member's informational page with a member's individual demographic profile to establish demographics for a member based on gender, age, ethnicity, knowledge of languages, disabilities, mobility, home ownership, household income, marital status, employment status, geographic location, decision changes on candidates, decision changes on issues, information queries, time reviewing candidates or issues before making an informed decision, and combinations thereof,
(e) collecting demographics of a plurality of individual members and creating demographic summaries, and
(f) granting at least one customer access to at least a portion of the demographic summaries.

9. A method according to claim 8, wherein the informational page can be revised by a member.

10. A method according to claim 9, wherein the demographic summaries are revised.

11. A method according to claim 8, wherein the at least one customer includes political scientists, politicians, media personnel, election officials and combinations thereof.

12. A method according to claim 8, wherein the informational page of a member contains more than one selection in a specific category of each of a political candidate, referendum, or election issue.
